(19) United States
(12) Patent Application Publication
(10) Pub. No.: US 2003/0217132 A1
(43) Pub. Date: Nov. 20, 2003

(54) System and method for remotely managing a computer system by a wireless communications device

(75) Inventors: David Middleton Batten, Leander, TX (US); Kyusun Chang, Austin, TX (US); Vandana Kumar, Austin, TX (US); Patrick Justin Laffey, Cedar Park, TX (US); Kim-Khanh Vu Tran, Austin, TX (US); Vi Trieu Tran, Austin, TX (US)

Correspondence Address: Gregory W. Carr, 670 Founders Square, 900 Jackson Street, Dallas, TX, 75202, US

(73) Assignee: International Business Machines Corporation, Armonk, NY (US)

(21) Appl. No.: 10/150,112

(22) Filed: May 16, 2002

(51) Int. Cl. G06F 15/16; G06F 15/173

(52) U.S. Cl. 709/223; 709/203

(57) ABSTRACT

The present invention provides a system and a method for remotely managing a server processing system, by using a wireless communications device. The wireless communications device sends a request for managing the server processing system to the server processing system through a gateway. The request is formatted in a first protocol in the wireless communications device, and is sent to the gateway. The gateway converts the request to be formatted in a second protocol, and sends the request to the server processing system. In response to the request, the server processing system sends a response, formatted in the second protocol, to the wireless communications device through the gateway. This time, the gateway converts the response to be formatted in the first protocol, and sends the response to the wireless communications device.

### BACKGROUND OF THE INVENTION

1. Field of the Invention

The invention relates generally to system management and, more particularly, to wireless system management for a server system.

2. Description of the Related Art

Traditional enterprise management software such as TME® by Tivoli® manages resources in the enterprise from a single console. Monitoring, reporting, and performing actions for the managed resources are executed in a central location by an operator or administrator. In an enterprise management system, servers, networks, and clients (including wireless communications devices) are part of the managed tools to be collected, categorized, and viewed.

A network problem can occur at any time, and an operator is expected to be present at the console to determine the cause of the problem and take necessary measures to fix the problem. If the operator is away from the console when such a problem occurs and is unable to come to the central location where the console is located, then the problem cannot be fixed until the operator arrives at the central location. Such a delay in fixing a network problem can be detrimental.

Therefore, there is a need for a system and a method for enabling a network administrator to monitor and/or manage a network and/or a network problem regardless of whether the administrator is available at the central location or not.

### SUMMARY OF THE INVENTION

The present invention provides a system and a method for remotely managing a server processing system, by using at least one wireless communications device. The at least one wireless communications device sends one or more requests for managing the server processing system to the server processing system through a gateway. The one or more requests are formatted in a first protocol in the at least one wireless communications device, and are sent to the gateway in the first protocol. The gateway converts the one or more requests to be formatted in a second protocol, and sends the one or more requests to the server processing system in the second protocol. In response to the one or more requests, the server processing system sends one or more responses, formatted in the second protocol, to the at least one wireless communications device through the gateway. This time, the gateway converts the one or more responses to be formatted in the first protocol, and sends the one or more responses to the at least one wireless communications device.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 depicts, in a block diagram, a wireless communications device in communication with a server processing system through a gateway according to the present invention;

FIG. 2 depicts a preferred embodiment of a network configuration according to the present invention;

FIG. 3 is a block diagram showing a preferred system architecture of a wireless communications device according to the present invention; and

FIG. 4 is a flow diagram showing an example of a sequence of action according to the present invention.

### DETAILED DESCRIPTION

In the following discussion, numerous specific details are set forth to provide a thorough understanding of the present invention. However, it will be obvious to those skilled in the art that the present invention may be practiced without such specific details. In other instances, well-known elements have been illustrated in schematic or block diagram form in order not to obscure the present invention in unnecessary detail.

It is further noted that, unless indicated otherwise, all functions described herein may be performed in either hardware or software, or some combination thereof. In a preferred embodiment, however, the functions are performed by a processor such as a computer or an electronic data processor in accordance with code such as computer program code, software, and/or integrated circuits that are coded to perform such functions, unless indicated otherwise.

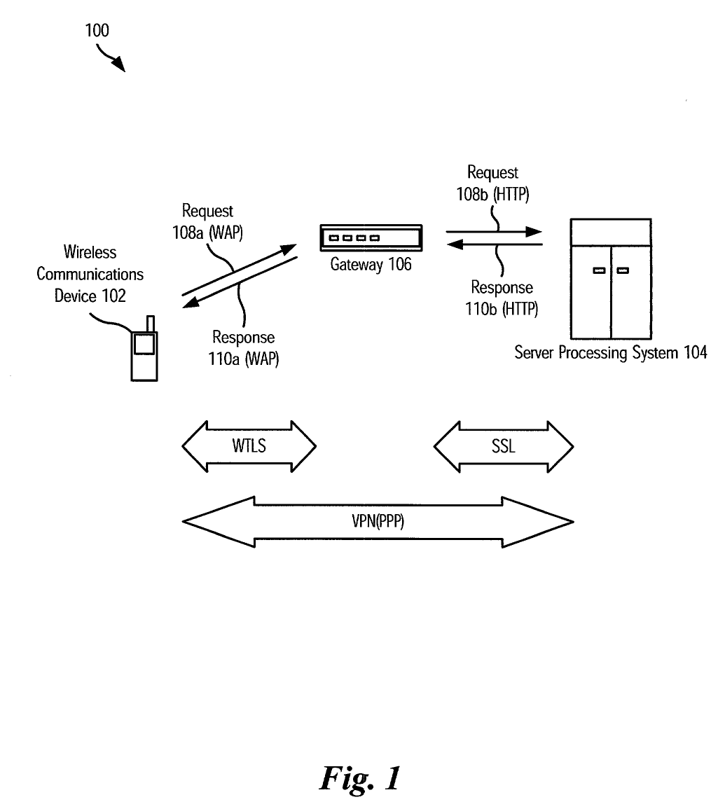

In FIG. 1, a reference numeral 100 generally designates a block diagram of a communications network according to the present invention. The block diagram 100 includes a wireless communications device 102 in communication with a server processing system 104 through a gateway 106. The wireless communications device 102 includes a handheld computer or portable computer having wireless communications capabilities. Alternatively, the wireless communications device 102 includes a cellular phone having computing capabilities. Preferably, the wireless communications device 102 is a personal digital assistant (PDA) or a cellular phone adopting wireless application protocol (WAP).

The server processing system 104 is generally any type of a computer system. For example, the server processing system 104 is a personal computer based on a Windows OS® operation system such as Windows NT@. Preferably, however, the server processing system 104 is a workstation based on a multitasking operation system such as UNIX®. Generally, a workstation is a high-performance computer used for graphics, simulations, and/or scientific applications. It is typically a RISC (reduced instruction set computer)-based computer that runs under some variation of UNIX®.

The gateway 106 includes a computer that performs protocol conversion between the first and second protocols. Examples of the gateway 106 include but are not limited to IBM Everyplace Wireless Gateway (EWG). The gateway 106 functions at layer 4 through 7 in the OSI (open system interconnection) model. The OSI model is well known in the relevant art of the present invention, and thus is not further described herein. Typically, gateways such as the gateway 106 perform complete conversion from one protocol to another rather than simply support one protocol from within another. Sometimes, routers can implement gateway functions.

Specifically, the wireless communications device 102 communicates with the gateway 106 by sending a request 108a to the gateway 106 and receiving a response 110a from the gateway 106. The response 110a is in response to the request 108a. Both the requests 108a and the response 110a are formatted in a first protocol for wireless communications. Preferably, the first protocol is WAP. On the other hand, the gateway 106 communicates with the server processing system 104 by sending a request 108b to the server processing system 104 and receiving a response 110b from the server processing system 104. The response 110b is in response to the request 108b. Both the requests 108b and the response 110b are formatted in a second protocol for Internet communications. Preferably, the second protocol is hypertext transport protocol (HTTP). It is noted that the requests 108a and 108b contain exactly the same request content but are in different formats. Similarly, the responses 110a and 110b contain exactly the same response content but are in different formats.

Under the OSI model, the transport layer (layer 4) is generally responsible for overall end-to-end validity and integrity of the transmission. Preferably, the transport layer for the communication between the wireless communications device 102 and the gateway 106 comprises wireless transport layer security (WTLS), whereas the transport layer for the communication between the gateway 106 and the server processing system 104 comprises secure socket layer (SSL). SSL is currently the leading security protocol on the Internet. As for the network layer (layer 3), virtual private network (VPN) is preferably used for the communication between the wireless communications device 102 and the server processing system 104. Typically, VPN is a private network that is configured within a public network. VPN enjoys the security of a private network via access control and encryption, while taking advantage of the economies of scale and built-in management facilities of large public networks.

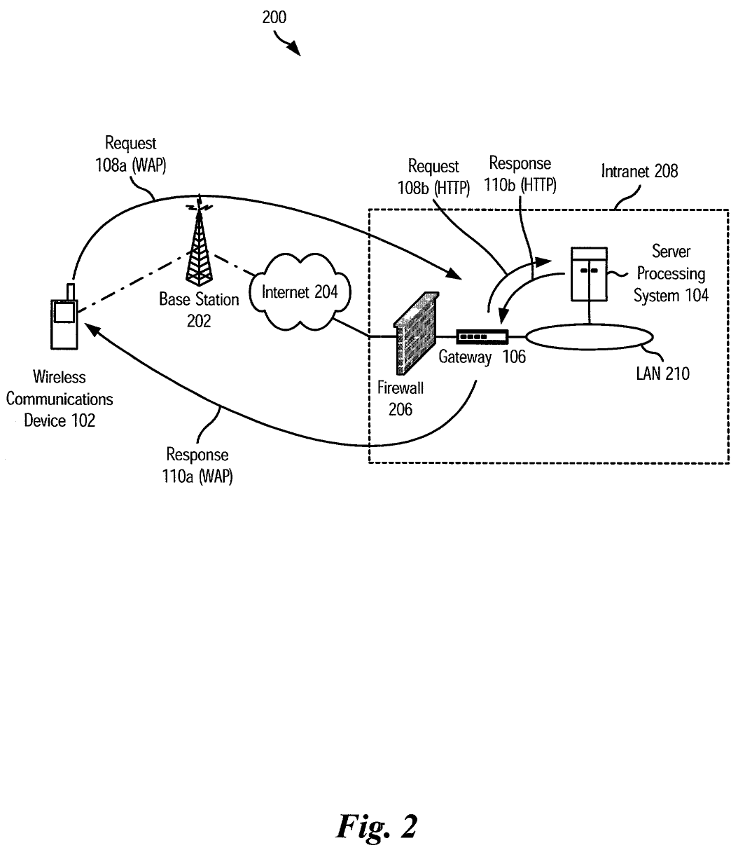

Now referring to FIG. 2, a network configuration 200 is provided as a preferred embodiment of the present invention. In this embodiment, the wireless communications device 102 is in communication with the server processing system 104 through a base station 202, the Internet 204, a firewall 206, and the gateway 106. The server processing system 104 resides in an intranet 208. Typically, the server processing system 104 is connected to a local area network (LAN) 210. Preferably, the server processing system 104 is connected to one or more other processing systems (not shown) via the LAN 210. Examples of such other processing systems include but are not limited to (a) another server processing system such as the server processing system 104 and/or (b) a client processing system managed by the server processing system 104.

Such other server processing systems may handle the request 108b independently and/or in cooperation with the server processing system 104. The client processing system, if any, may not receive the request 108b but may be managed by the server processing system 104 to have an indirect management capability of the request 108b. For example, when a user (not shown) would like to check if a particular client processing system (not shown) is alive, the user may “ping” the particular client system, (i.e., determine whether the particular client processing system is online by sending out a packet (not shown) and waiting for a response (not shown)). The request 108b containing the ping operation is received by the server processing system 104, which in turn performs the ping operation to the particular client processing system. The result of that operation is then collected, and forwarded to the wireless communications device 102, by the server processing system 104.

Specifically, the wireless communications device 102 communicates with the base station 202 over the air. The base station 202 is only part of a voice telephone network (not shown) such as public switched telephone network (PSTN). The base station 202 is connected to the Internet 204. The Internet 204 refers to a large network made up of a number of smaller networks. The Internet 204 comprises more than 65 million computers in more than 100 countries covering commercial, academic, and government endeavors. The Internet 204 is also connected to the intranet 208. The intranet 208 refers to a private network (e.g., any in-house LAN and/or client-server system) connected to, but not freely accessible by the general public from, the Internet 204.

The intranet 208 typically has the firewall 206 for security purposes. The firewall 206 generally refers to a system and a method for keeping a network secure from intruders. The firewall 206 can be a single router (not shown) that filters out unwanted packets or may comprise a combination of routers and servers (not shown) each performing some type of firewall processing. The firewall 206 is used to give users secure access to the Internet 204 as well as to-separate a company's public Web server (not shown) from its internal network such as the LAN 210. The firewall 206 is connected to the gateway 106. The gateway 106 is connected to the LAN 210 to communicate with the server processing system 104. Alternatively, the gateway 106 is connected directly to the server processing system 104 in a simpler configuration (not shown). Alternatively, the gateway 106 may be incorporated between the base station 202 and the Internet 204, if a wireless service provider (not shown) chooses to do so.

As shown in FIG. 1 and explained above, the wireless communications device 102 communicates with the gateway 106 by sending the request 108a to the gateway 106 and receiving the response 110a from the gateway 106. The request 108a and the response 110a are transmitted through the base station 202, the Internet 204, and the firewall 206. Also, the gateway 106 communicates with the server processing system 104 by sending the request 108b and receiving the response 110b. The gateway 106 receives the request 108a formatted in the first protocol such as WAP from the wireless communications device 102 and converts it into the request 108b formatted in the second protocol such as HTTP. Then, the gateway 106 sends the request 108b to the server processing system 104. In response, the server processing system 104 sends the response 110b formatted in the second protocol to the gateway 106, which then converts it into the response 110a formatted in the first protocol and sends the response 110a to the wireless communications device 102.

Preferably, the gateway 106 receives the request 108a such as a wireless session protocol (WSP) request over user datagram protocol (UDP) and/or transmission control protocol (TCP) and converts the request 108a into the request 108b such as an HTTP request over TCP. The gateway 106 also receives the response 110b such as an HTTP response and converts the response 110b into the response 110a such as a WSP response. Preferably, these protocol conversions are performed by converting a header in a request and/or a response. Contents (OSI layer 6-7) are encoded as wireless markup language (WML) and/or extensible markup language (XML) to be sent along to the wireless communications devices 102. Therefore, the firewall 206 (normally only open for HTTP/HTTPS) is able to accommodate WSP protocol.

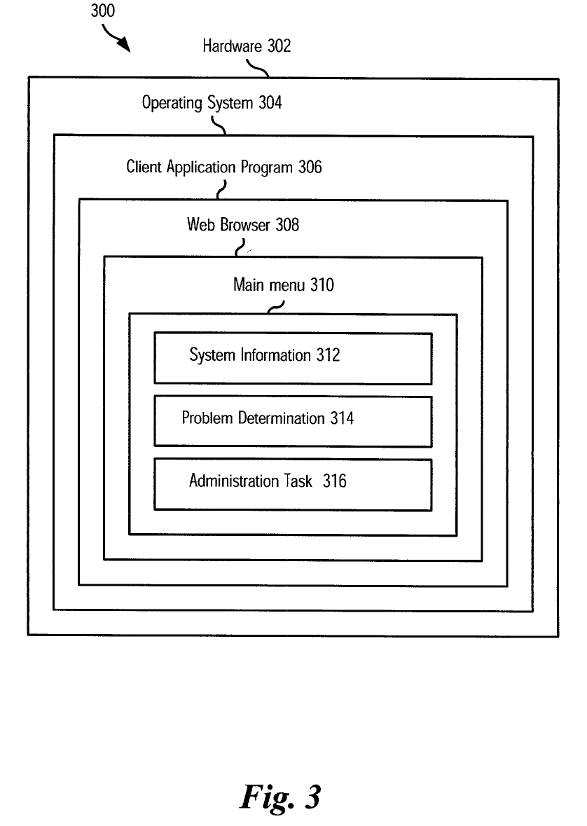

Now referring to FIG. 3, a reference numeral 300 designates a block diagram showing a preferred system architecture of the wireless communications device 102. The wireless communications device 102 comprises hardware 302 and an operating system 304. The hardware 302 is generally divided into two portions (not shown), a first portion being responsible for sending and/or receiving data, and a second portion for processing data. For example, the first portion of the hardware 302 may comprise an antenna (not shown) for receiving a signal carrying data and some circuitry (not shown) for processing the signal to extract the data. In this example, the second portion of the hardware 302 may comprise a processor (not shown) for processing the data, a memory (not shown) connected to the processor for storing the data and/or the end result of the data processing, and a user interface connected to the processor and the memory. It is generally well known in the art that the wireless communications device 102 would have this type of hardware configuration as briefly illustrated in this example. Therefore, further details and/or variations on the configuration of the hardware 302 are not disclosed herein.

The operating system 304 interacts with the hardware 302 particularly, the second portion of the hardware 302) for data processing and other computing tasks. Preferably, The operating system 304 is specifically designed to operate in the wireless communications device 102. Examples of the operating system 304 include the Palm OS® operating system, available from Palm, Inc., Santa Clara, Calif. (http://www.palm.com). The operating system 304 also provides an environment in which a client application program 306 is properly executed by the hardware 302. The client application program 306 is essentially a set of instructions executable by a processor (not shown) in the hardware 302 under the environment provided by the operating system 304. The client application program 306 includes a web browser 308. The web browser 308 is one type of the client application program 306 and enables a user (not shown) to browse the World Wide Web (hereinafter “the Web”) (not shown) on the Internet 204 of FIG. 2. Generally, the Web is referring to a specific type of information that is available on the Internet 204. Other types of information available on the Internet 204 include e-mail messages and newsgroup news, for example. The web browser 308 is a preferred client application program 304 in the present invention.

The web browser 308 typically shows a web page (not shown) containing, preferably, a main menu 310. The main menu 310 preferably shows a list of courses of action to be performed. For example, such courses of action include a “system information” category 312, a “problem determination” category 314, and an “administration task” category 316. The “system information” category 312 lists general system information such as vital product data (VPD) and/or error logs. In the “problem determination” category 314, the user determines problems by looking into various system resource conditions. In the “administration task” category 316, the user administers system and/or application resources by starting and/or stopping system resources and applications. Preferably, the user selects one of these three categories for specific tasks desired under given circumstances. The following table shows some examples of such specific tasks that may be included in each category:

| | |
|---|---|
| System | VFD and/or ERROR: Display or clear system error |
| Information | logs. |
| | RAM, CPU, and/or DISK: Display CPU Usage, disk |
| | total and free space, and total and free paging |
| | space. |
| Problem | Ping a host: Ping a host with a hostname or an |
| Determination | IP address. |
| | Process Management: Manage processes by owner, |
| | display a percentage of a total CPU time used |
| | for a proces, etc. |
| | Device Management: List on-line and off-line |
| | devices. |
| Administration | Wall Users: Send standard or customized messages |
| Task | to logged-on users. |
| | Files, File systems, and/or Paging space: Clean |
| | up and/or expand file system; mount and/or |
| | unmount file system; and view paging spaces. |
| | Process and/or Subsystem: List and kill |
| | processes; and/or list, query, start, stop, |
| | refresh, and/or trace subsystems. |
| | Applications and/or Print: Stop and/or start |
| | applications; and/or start, stop, and/or cancel |
| | print jobs. |
| | Reboot and/or Shutdown: Reboot and/or shutdown |
| | the system. |

A user interface (not shown) of the wireless communications device 102 should provide the user with all or part of the specific tasks provided in this table and perhaps other related tasks not specifically identified herein. Preferably, such a user interface may comprise a video display showing the main menu 310 in a web page (not shown). In the main menu 310, the user can select a category. Such a selection leads the user to a subsequent web page linked to the selected category. The subsequent web page contains either specific tasks associated with the selected category or subcategories, if any, under the selected category. For example, if the user selected the “system information” category 312, then the subsequent web page should provide the user with the two subcategories as shown in the above table. Each of these subcategories lists specific tasks under the subcategories.

The user, preferably an administrator of the server processing system 104, should tell from a pre-login notification what specific action is required, or may look for any abnormal conditions and remedy them by anticipating certain situations (such as planned outages).

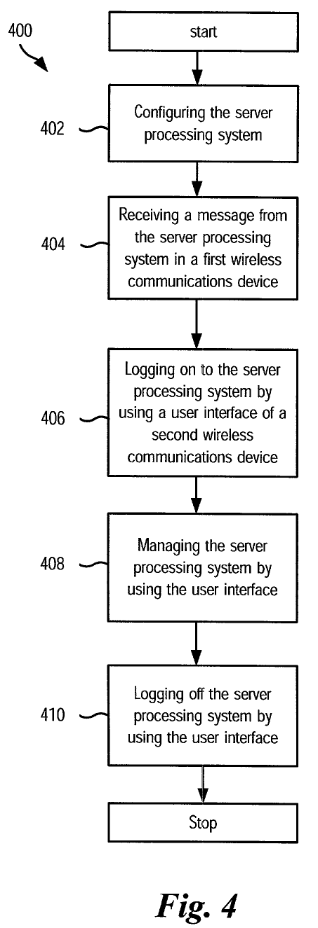

In FIG. 4, a reference numeral 400 designates a flow diagram depicting a preferred method of a user of at least one wireless communications device such as the wireless communications device 102, preferably an administrator of the server processing system 104, remotely managing the server processing system 104 by using the at least one wireless communications device, according to the present invention. In step 402, the user configures the server processing system 104 for conditions requiring notification to the user of such conditions. Optionally, this configuring step 402 includes entering the notification destination through which the server processing system 104 can contact the at least one wireless communications device such as the wireless communications device 102. For example, such notification destination includes the phone number and/or a short message service (SMS) address of the at least one wireless communications device.

In step 404, the user receives a message from the server processing system 104 in a first wireless communications device, according to the present invention. For example, such a message includes an SMS message.

In step 406, the user logs on to the server processing system 104 by using a user interface of a second wireless communications device, according to the present invention. Typically, the user is prompted to enter a password in order to log on to the server processing system 104 as an administrator. Preferably, the first and second communications devices may be the same device. For example, the first and second communications devices are the same PDA. Alternatively, the first and second communications devices may be different devices. For example, the first wireless communications device may be a pager, and the second wireless communications device may be a WAP phone or a PDA.

In step 408, the user manages the server processing system 104 by using the user interface, according to the present invention. Here, the user is presented with the main menu 310 of FIG. 3. As illustrated above in reference to FIG. 3, the user navigates and performs one or more desired tasks including tasks related to the message received in step 404. For example, if the message is a notification of an action, such as a job completion, then the user checks the job's status, among other things.

In step 410, the user logs off the server processing system 104 by using the user interface. Preferably, the user disconnects the communication link between the second wireless communications device and the server processing system 104.

It will be understood from the foregoing description that various modifications and changes may be made in the preferred embodiment of the present invention without departing from its true spirit. This description is intended for purposes of illustration only and should not be construed in a limiting sense. The scope of this invention should be limited only by the language of the following claims.

1. A system for remotely managing a server processing system by using at least one wireless communications device, the system comprising:
a client application program installed in the at least one wireless communications device and used to send one or more requests for managing the server processing system and receive one or more responses to the one or more requests, wherein the one or more requests and the one or more responses are formatted in a first protocol;
a server application program installed in the server processing system and used to receive the one or more requests and send the one or more responses, wherein the one or more requests and the one or more responses are formatted in a second protocol; and
a gateway, in communication with both the server processing system and the at least one wireless communications device, for converting the first protocol into the second protocol for the one or more requests and converting the second protocol into the first protocol for the one or more responses.

2. The system of claim 1, wherein the server processing system is a workstation based on a multitasking operating system.

3. The system of claim 1, wherein the at least one wireless communications device is a mobile phone having a means for providing wireless access to the Internet.

4. The system of claim 1, wherein the at least one wireless communications device is a portable computer having a means for providing wireless access to the Internet.

5. The system of claim 1, wherein the first protocol is a wireless application protocol (WAP).

6. The system of claim 1, wherein the second protocol is a hypertext transport protocol (HTTP).

7. The system of claim 1, wherein the one or more requests include a wireless session protocol (WSP) request.

8. The system of claim 1, wherein the client application program includes a web browser.

9. The system of claim 1, wherein the server application program runs as a standard HTTP server plug-in on the server processing system.

10. The system of claim 1, wherein the one or more requests include requests for system information of the server processing system.

11. The system of claim 1, wherein the one or more requests include requests for problem determination of the server processing system.

12. The system of claim 1, wherein the one or more requests include requests for administrative tasks of the server processing system.

13. The system of claim 1, wherein the one or more responses include responses for system information of the server processing system.

14. The system of claim 1, wherein the one or more responses include responses for problem determination of the server processing system.

15. The system of claim 1, wherein the one or more responses include responses for administrative tasks of the server processing system.

16. The system of claim 1, wherein the wireless communications device receives a message from the server processing system indicating a condition requiring attention to the wireless system.

17. A method for remotely managing a server processing system by using at least one wireless communications device, the method comprising the steps of:
sending one or more requests for managing the server processing system by the at least one wireless communications device, wherein the one or more requests are formatted in a first protocol;
receiving one or more responses to the one or more requests by the at least one wireless communications device, wherein the one or more responses are formatted in the first protocol;
receiving the one or more requests by the server processing system, wherein the one or more requests are formatted in a second protocol;
sending the one or more responses by the server processing system, wherein the one or more responses are formatted in the second protocol;
converting the first protocol into the second protocol for the one or more requests; and
converting the second protocol into the first protocol for the one or more responses.

18. The method of claim 17, wherein the step of sending one or more requests comprises connecting to the Internet.

19. The method of claim 17, wherein the step of receiving one or more responses comprises connecting to the Internet.

20. The method of claim 17, wherein the step of sending one or more requests comprises using WAP protocol.

21. The method of claim 17, wherein the step of receiving one or more responses comprises using WAP protocol.

22. The method of claim 17, wherein the step of receiving the one or more requests comprises using HTTP protocol.

23. The method of claim 17, wherein the step of sending the one or more responses comprises using HTTP protocol.

24. The method of claim 17, wherein the step of sending one or more requests comprises using a web browser installed in the at least one wireless communications device.

25. The method of claim 17, wherein the step of receiving one or more responses comprises using a web browser installed in the at least one wireless communications device.

26. The method of claim 17, wherein the one or more requests include requests for system information of the server processing system.

27. The method of claim 17, wherein the one or more requests include requests for problem determination of the server processing system.

28. The method of claim 17, wherein the one or more requests include requests for administrative tasks of the server processing system.

29. The method of claim 17, wherein the one or more responses include responses for system information of the server processing system.

30. The method of claim 17, wherein the one or more responses include responses for problem determination of the server processing system.

31. The method of claim 17, wherein the one or more responses include responses for administrative tasks of the server processing system.

32. The method of claim 17, further comprising the step of receiving a message from the server processing system indicating a condition requiring attention to the wireless system.

33. A method for remotely managing a server processing system by using at least one wireless communications device, the method comprising the steps of:
configuring the server processing system by entering conditions under which notification to an administrator is required;
receiving a message in a first wireless communications device, the message indicating the conditions under which notification to the administrators is required;
logging on to the server processing system by using a user interface of a second wireless communications device;
managing the server processing system by using the user interface; and
logging off the server processing system by using the user interface.

34. The method of claim 33, wherein the first and second wireless communications devices are the same wireless communications device.

35. The method of claim 17, wherein the step of managing the server processing system comprises connecting to-the Internet.

36. The method of claim 17, wherein the step of managing the server processing system comprises using a web browser installed in the at least one wireless communications device.

37. The method of claim 33, wherein the step of configuring the server processing system comprises running a server application program as a standard HTTP server plug-in on the server processing system.

38. A computer program product for remotely managing a server processing system by at least one wireless communications device, the computer program product having a medium with a computer program embodied thereon, the computer program comprising:
computer program code for sending one or more requests for managing the server processing system by the at least one wireless communications device, wherein the one or more requests are formatted in a first protocol;
computer program code for receiving one or more responses to the one or more requests by the at least one wireless communications device, wherein the one or more responses are formatted in the first protocol;
computer program code for receiving the one or more requests by the server processing system, wherein the one or more requests are formatted in a second protocol computer program code for sending the one or more responses by the server processing system, wherein the one or more responses are formatted in the second protocol;
computer program code for converting the first protocol into the second protocol for the one or more requests; and
computer program code for converting the second protocol into the first protocol for the one or more responses.

39. The computer program product of claim 38, wherein the server processing system is a workstation based on a multitasking operating system.

40. The computer program product of claim 38, wherein the at least one wireless communications device is a mobile phone having a means for providing wireless access to the Internet.

41. The computer program product of claim 38, wherein the at least one wireless communications device is a portable computer having a means for providing wireless access to the Internet.

42. The computer program product of claim 38, wherein the first protocol is a wireless application protocol (WAP).

43. The computer program product of claim 38, wherein the second protocol is a hypertext transport protocol (HTTP).

44. The computer program product of claim 38, wherein the one or more requests include a wireless session protocol (WSP) request.

45. The computer program product of claim 38, wherein the at least one wireless communications device has a client application program, which includes a web browser.

46. The computer program product of claim 38, wherein the server processing system has a server application program running as a standard HTTP server plug-in on the server processing system.

47. The computer program product of claim 38, wherein the one or more requests include requests for system information of the server processing system.

48. The computer program product of claim 38, wherein the one or more requests include requests for problem determination of the server processing system.

49. The computer program product of claim 38, wherein the one or more requests include requests for administrative tasks of the server processing system.

50. The computer program product of claim 38, wherein the one or more responses include responses for system information of the server processing system.

51. The computer program product of claim 38, wherein the one or more responses include responses for problem determination of the server processing system.

52. The computer program product of claim 38, wherein the one or more responses include responses for administrative tasks of the server processing system.

53. The computer program product of claim 38, wherein the at least one wireless communications device receives a message from the server processing system indicating a condition requiring attention to the wireless system.
